(19) United States
(12) Patent Application Publication
(10) Pub. No.: US 2016/0336797 A1
(43) Pub. Date: Nov. 17, 2016

(54) SYSTEMS AND METHODS FOR MANAGING POWER SOURCES FOR A PLURALITY OF LUMINAIRES

(71) Applicant: KENALL MANUFACTURING COMPANY, Kenosha, WI (US)

(72) Inventors: Kevin Dahlen, Lindenhurst, IL (US); Joseph Welch, Kenosha, WI (US)

(21) Appl. No.: 14/711,159

(22) Filed: May 13, 2015

(51) Int. Cl. H02J 9/06; H05B 37/02

(52) U.S. Cl. CPC H02J 9/061; H05B 37/0245

(57) ABSTRACT

Embodiments are provided for systems and methods of managing a lighting system. According to certain aspects, a control board may interface with a controller for an automatic transfer switch (ATS) that is connected to a main power source and an emergency power source. The control board may retrieve signals from the controller and determine, from the signals, the current power mode for the lighting system. The control board may access an appropriate lighting setting and transmit the appropriate lighting setting to a set of luminaires, which may implement the appropriate lighting setting to operate according to the current power mode.

### FIELD

This application generally relates to lighting systems. In particular, this application relates to platforms and techniques for managing multiple operating modes within a lighting system.

### BACKGROUND

Most commercial buildings, parking structures, transportation areas or structures, and the like are equipped with lighting systems that typically include several luminaires or light fixtures configured to illuminate certain areas. The lighting systems support different modes of operation, specifically a primary or “main” mode as well as an emergency mode. When a lighting system is operating in the main mode, the luminaires are powered by a main or utility power source. When the lighting system is operating in the emergency mode, the luminaires are powered by an emergency power source. Typically, the emergency mode has requirements that are defined by various codes, standards, and/or regulations which can be met using various equipment and configurations.

In typical lighting systems, an automatic transfer switch (ATS) facilitates transferring a lighting system from a main mode to an emergency mode (and vice-versa). In particular, the ATS transfers from a main or utility power source to an emergency power source (and vice-versa). In conventional lighting systems, one set of luminaires is dedicated for the main mode and another set of luminaires is dedicated for the emergency mode. Similarly, the ATS interfaces with separate wiring configurations for the multiple sets of luminaires, whereby one set of wiring and conduit is dedicated for the set of main luminaires and another set of wiring and conduit is dedicated for the set of emergency luminaires.

However, the separate wiring configurations for the multiple sets of luminaires are costly to install and ultimately require more space to accommodate. Accordingly, there is an opportunity for lighting systems having configurations that reduce the complexity and cost required to implement and manage multiple lighting modes.

### SUMMARY

In an embodiment, a control board for facilitating multiple lighting modes for a set of luminaires is disclosed. The control board may include a communication module adapted to interface with the set of luminaires, a memory storing a set of computer-executable instructions, at least one port for interfacing with a controller for an automatic transfer switch (ATS), and a processor adapted to interface with the communication module, the memory, and the at least one port. The processor may be configured to execute the set of computer-executable instructions to cause the processor to receive, via the at least one port, at least one signal from the controller for the ATS, determine, based on the at least one signal, that the emergency power mode is initiated, generate an instruction to implement an emergency lighting setting associated with the emergency power mode, and transmit the instruction to the set of luminaires via the communication module, the set of luminaires configured to execute the instruction to implement the emergency lighting setting.

In another embodiment, a computer-implemented method of facilitating multiple lighting modes for a set of luminaires is disclosed, the multiple lighting modes including a main power mode having a main lighting setting and an emergency power mode having an emergency lighting setting. The method may include receiving, by a processor via at least one port, at least one signal from a controller for an automatic transfer switch (ATS) connected to a main power source and an emergency power source, determining, by the processor based on the at least one signal, that the emergency power mode is initiated, generating an instruction to implement the emergency lighting setting associated with the emergency power mode, and transmitting the instruction to the set of luminaires via a communication module, the set of luminaires configured to execute the instruction to implement the emergency lighting setting with power from the emergency power source.

In an additional embodiment, a system for facilitating multiple lighting modes for a set of luminaires is disclosed. The system may include a controller for an automatic transfer switch (ATS) connected to an emergency power source and a main power source, and a control board configured to interface with the controller for the ATS via at least one port. The control board may include a communication module adapted to interface with a set of luminaires, a memory storing a set of computer-executable instructions, and a processor adapted to interface with the communication module and the memory. The processor may be configured to execute the set of computer-executable instructions to cause the processor to receive, via the at least one port, at least one signal from the controller for the ATS, determine, based on the at least one signal, that the ATS is facilitating a transfer from a first power mode to a second power mode, generate an instruction to implement a lighting setting associated with the second power mode, and transmit the instruction to the set of luminaires via the communication module, the set of luminaires configured to execute the instruction to implement the lighting setting.

In a further embodiment, a luminaire configured to implement multiple lighting settings is disclosed. The luminaire may include a communication module adapted to interface with a control board, at least one lamp, a memory storing at least a main lighting setting associated with a main power mode and an emergency lighting setting associated with an emergency power mode, and a processor adapted to interface with the communication module, the at least one lamp, and the memory. The processor may be configured to receive, from the control board via the communication module, an instruction to implement the emergency lighting setting associated with the emergency power mode, in response to receiving the instruction, access, from the memory, the emergency lighting setting associated with the emergency power mode, and cause the at least one lamp to output light according to the emergency lighting setting, the at least one lamp receiving power from an emergency power source.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a diagram of a prior art configuration of a lighting system.

FIG. 2 is a diagram of a configuration of a lighting system in accordance with some embodiments.

FIG. 3 is a schematic of an automatic transfer switch (ATS) and related components in accordance with some embodiments.

FIG. 4 is a signal diagram associated with managing various lighting modes in a lighting system in accordance with some embodiments.

FIG. 5 is a flow diagram associated with managing various lighting modes in a lighting system in accordance with some embodiments.

FIG. 6 is a schematic diagram of an example control device in accordance with some embodiments.

### DETAILED DESCRIPTION

The novel methods and systems disclosed herein generally relate to lighting systems and methods of configuring lighting systems for different modes of operation. In certain situations, a lighting system may be powered by a main or utility power supply. In other situations, such as if the main power supply experiences an outage, the lighting system may be powered by an emergency power supply. The corresponding main power lighting mode and emergency power lighting mode may have different operating settings or parameters. For example, the emergency power lighting mode may be at least partially dictated by building codes and/or other regulations.

To accommodate accurate operation of the different lighting modes, conventional lighting systems have different sets of luminaires that respectively implement the different lighting modes. In particular, one set of luminaires is operational when the main power lighting mode is active, and another set of luminaires is operational when the emergency power lighting mode is active. These sets of luminaires may have lighting settings programmed therein and may operate accordingly.

In contrast, in the lighting system according to the present embodiments, a single set of luminaires is used to operate multiple lighting modes. The lighting system may include an automatic transfer switch (ATS) and a controller for the ATS, as well as a control board that may interface with the controller for the ATS. The control board may send commands or instructions to the set of luminaires to implement respective lighting settings corresponding to the multiple lighting modes.

In operation, the control board may receive one or more signals from the controller for the ATS and determine, from the one or more signals, a current lighting mode (e.g., main power or emergency power). The control board may generate an instruction to implement a specific lighting setting that corresponds to the current lighting mode and may transmit the instruction to the set of luminaires. After receiving the instruction, the set of luminaires may locally access the specific lighting setting and implement the specific lighting setting to operate according to the proper lighting mode. The present embodiments further enable a user to remotely access the lighting settings and modify the lighting settings as desired.

The systems and methods offer numerous improvements and benefits over existing implementations. First, by facilitating operation of the multiple lighting modes with a single set of luminaires, the systems and methods reduce the amount of physical components needed to install the lighting system, including the luminaires themselves as well as conduit, switches, meters, light fittings, insulated conductors, and/or the like. Second, the systems and methods may leverage existing hardware components, such as the ATS and the controller for the ATS, thus reducing the amount of complexity needed for implementation. Third, the systems and methods enable users to remotely access and modify the lighting systems, which the systems and methods may dynamically transmit to the luminaires via a wired or wireless communication for real-time implementation.

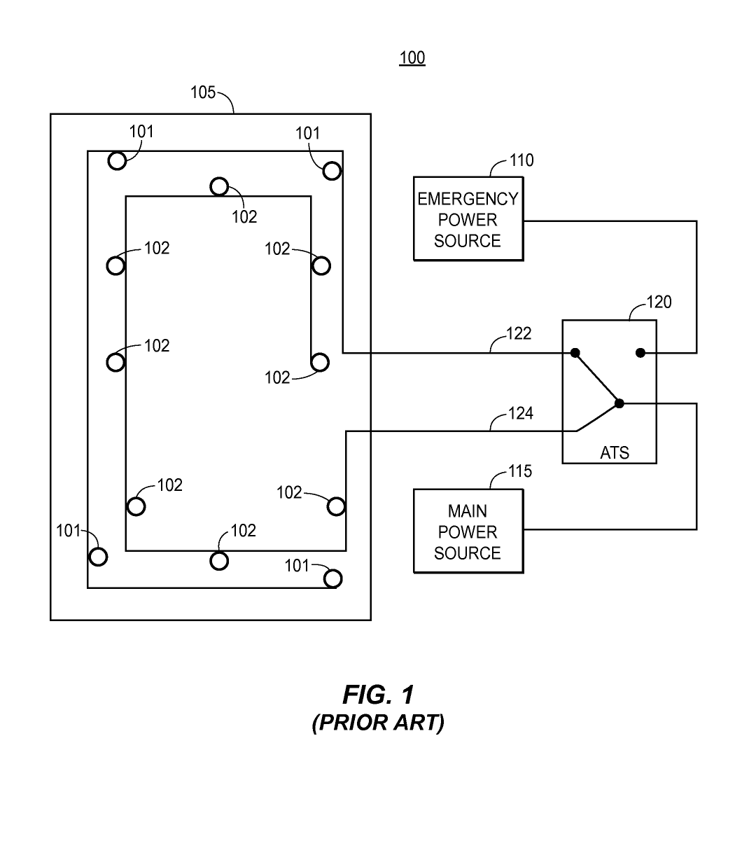

Referring to FIG. 1, depicted is a prior art lighting system 100 that may be implemented in various buildings, environments, and/or the like. For example, the lighting system 100 can be included in a parking garage (or a floor or section of the parking garage), commercial building (or a portion thereof), roadway, tunnel, or other transportation structure (or a portion thereof), residential home or building, or other indoor or outdoor space or environment.

As illustrated in FIG. 1, the lighting system 100 depicts a venue 105 in which a plurality of luminaires may be installed. In particular, the venue 105 may include a first set of luminaires 101 and a second set of luminaires 102. It should be appreciated that the sets of luminaires 101, 102 may respectively include various amounts of luminaires and may be various types such as, for example, fluorescent, incandescent, plasma, light-emitting diode (LED), or others.

The lighting system 100 may further include an emergency power source 110 and a main power source 115. The emergency power source 110 may be any battery, generator, or combination thereof, or any other type of emergency power supply. The main power source 115 may be utility electric power that may be regulated and/or operated by an electric utility, or any other type of main power supply. The lighting system 100 may further include an ATS 120 that is configured to transfer a power load between the emergency power source 110 and the main power source 115. In particular, when the main power source 115 fails, the ATS 120 may transfer the power load to the emergency power source 110. Similarly, when the main power source 115 is subsequently available, the ATS 120 may transfer the power load back to the main power source 115.

As illustrated in FIG. 1, there are two wiring configurations 122, 124 to the respective sets of luminaires 101, 102. Each of the wiring configurations 122, 124 may include electrical wiring and associated devices such as conduit, switches, meters, light fittings, insulated conductors, and/or the like. The wiring configuration 122 may supply emergency or egress power from the emergency power source 110, via the ATS 120, to the first set of luminaires 101. Similarly, the wiring configuration 124 may supply main power from the main power source 115, via the ATS 120, to the second set of luminaires 102. In some implementations, because of the configuration of the ATS 120, only one of the sets of luminaires 101, 102 may be powered at a time. However, it should be appreciated that the sets of luminaires 101, 102 may both be powered at the same time.

As understood in the art, the configuration of the first set of luminaires 101 may be dictated by a set of building codes and/or other regulatory codes related to emergency light. For example, one code may specify that the first set of luminaires 101 provide an average of one footcandle of light along a path of egress. For further example, another code may require a minimum of ninety (90) minutes on battery power during a power outage along the path of egress.

Because of the set of building and/or regulatory codes related to emergency light, and/or because of other factors, the first set of luminaires 101 may be configured differently than the second set of luminaires 102. In particular, the first set of luminaires 101 may have a different amount or type of luminaires and/or may be disposed or installed in a different location. Further, the first set of luminaires 101 may be programmed to output light differently than the second set of luminaires 102. Additionally, the wiring configuration 122 for the first set of luminaires 101 is separate from the wiring configuration 124 for the second set of luminaires 102. As a result, the configuration of the conventional lighting system 100 not only requires the inclusion of both sets of luminaires 101, 102 and both wiring configurations 122, 124, but also necessitates the installation and configuration of both sets of luminaires 101, 102 and both wiring configurations 122, 124.

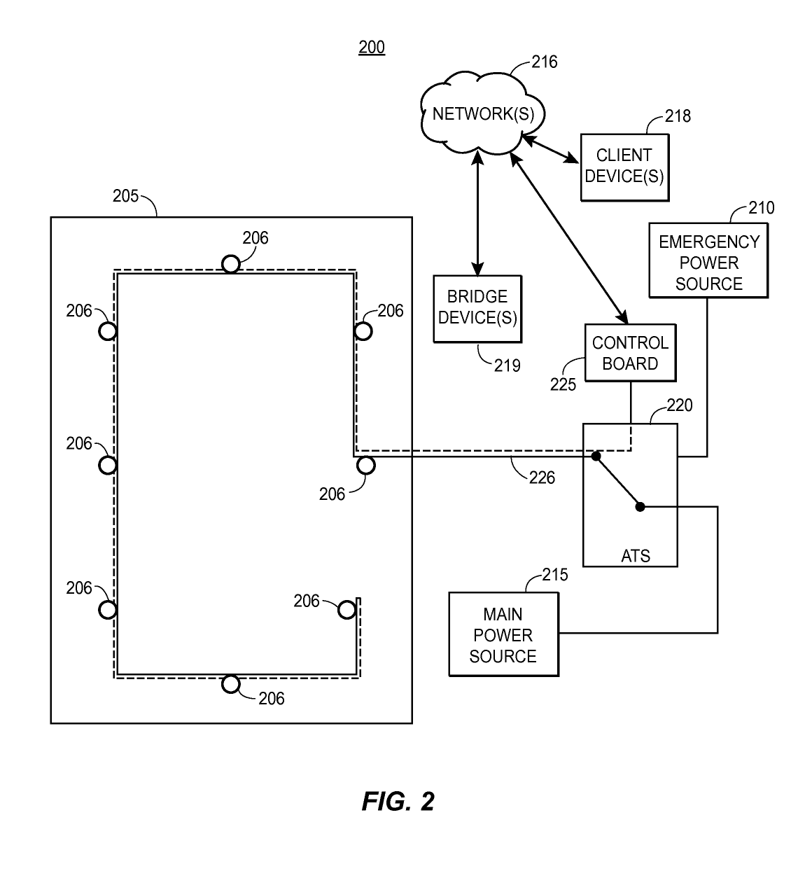

Referring to FIG. 2, depicted is a lighting system 200 according to the present embodiments. The lighting system 200 includes a venue 205 (such as the venue 105 discussed with respect to FIG. 1), an emergency power source 210 (such as the emergency power source 110 discussed with respect to FIG. 1), a main power source 215 (such as the main power source 115 discussed with respect to FIG. 1), and an ATS 220 (such as the ATS 120 discussed with respect to FIG. 1).

According to embodiments, the ATS 220 of the lighting system 200 may include an automatic transfer switch controller (ATSC) (not shown in FIG. 2). The ATSC may be a processor-based transfer control system that may manage the supply of power to a set of luminaires 206 installed in or otherwise associated with the venue 205. In particular, the ATSC may support normal (main) and emergency source monitoring, emergency set starting, and power switch control functions. The ATSC may include various input and output ports to enable the ATSC to connect to other components of the lighting system 200, such as the ATS 220 itself.

As depicted in FIG. 2, the ATS 220 may connect to the set of luminaires 206 via a wiring configuration 226 which may include electrical wiring and associated devices such as conduit, switches, meters, light fittings, insulated conductors, and/or the like. The wiring configuration 226 may supply, via the ATS 220, the set of luminaires 206 with either emergency power from the emergency power source 210 or main power from the main power source 215.

The lighting system 200 may further include a control board 225 that may interface with the ATSC of the ATS 220. In particular, the control board 225 may connect to the ATSC via one or more respective ports of the control board 225 and the ATSC. The control board 225 may be configured to generate and send commands or instructions to the set of luminaires 206 to implement various sets of lighting settings corresponding to operation of the set of luminaires 206. Each set of lighting settings may include various parameters or settings including, for example, dim levels, output wattages, timeouts, and/or the like, whereby each set of lighting settings may also include a schedule specifying which settings should be used based on time of day, day or week, and/or other timing parameters. According to embodiments, one of the set of lighting settings may be an emergency lighting setting and another of the set of lighting settings may be a main lighting setting. The emergency lighting setting may include parameters that comply with any applicable building code(s) and/or other regulatory code(s)

In operation, the control board 225 may receive one or more status or operating signals from the ATSC, from which the control board 225 may determine which power source (main 215 or emergency 210) is currently active and/or determine whether the ATS 220 is facilitating a transfer form one power source to another. For example, the control board 225 may receive a “gen start” command from the “gen start” port of the ATSC. The control board 225 may generate a command or instruction to implement a set of lighting settings that corresponds to the active/initiated power source or the power source to which the ATS 220 is transferring. For example, if the emergency power source 210 is active/initiated or being transferred to, the control board 225 may generate a command to implement the emergency lighting setting, and if the main power source 215 is active/initiated or being transferred to, the control board 225 may generate a command to implement the main lighting setting.

The control board 225 may transmit the generated command to each of the set of luminaires 206. In particular, the control board 225 may transmit the generated command via one or more bridge devices 219, whereby portion(s) of the set of luminaires 206 may be connected to the bridge device(s) 219. For example, each bridge device may connect to up to one hundred (100) of the set of luminaires 206. In one implementation, the control board 225 may connect to the bridge device(s) 219 via a wireless network, such as a network 216 as depicted in FIG. 2.

According to embodiments, the network 216 can facilitate any type of data communication via any standard or technology (e.g., e.g., GSM, CDMA, TDMA, WCDMA, LTE, EDGE, OFDM, GPRS, EV-DO, UWB, IEEE 802 including Ethernet, WiMAX, Wi-Fi, and/or others). Additionally, the network 216 may support various short range communications (e.g., Bluetooth®, RFID, NFC, ZigBee®, Z-Wave®, Insteon®, or universal powerline bus (UPB)) between and among the control board 225, the bridge device(s) 219, and the set of luminaires 206. In another implementation, the control board 225 may directly communicate with the set of luminaires 206 via the network 216. In a further implementation, the control board 225 may communicate with the set of luminaires 206 via a wired connection.

According to embodiments, each of the set of luminaires 206 may be configured with a luminaire control board that may interface with the control board 225 either directly or via the appropriate bridge device 219. The luminaire control board may manage operation of the corresponding luminaire 206, including controlling luminaire light output based on various configurable parameters such as occupancy status, scheduling/timing parameters, special events, utility rate schedules, and/or the like. The luminaire control board may also perform various system measurements (e.g., power consumption, occupancy events, and light level). The luminaire control board may maintain various data such as schedule information and zone information in local memory. Additionally, the local memory of the luminaire control board may store multiple sets of lighting settings, such as an emergency lighting setting and a main lighting setting.

Thus, each of the luminaire control boards may receive the generated command that originates from the control board 225, where the command specifies the appropriate lighting setting for the set of luminaires 206 to implement. Based on the command, the luminaire control boards may then access the appropriate lighting setting from the memory and implement the appropriate lighting setting. In one implementation, all of the set of luminaires 206 may maintain uniform lighting settings (i.e., each of the set of luminaires 206 may operate in a uniform manner depending on the lighting mode). In another implementation, individual luminaires 206 may maintain individual lighting settings (i.e., each of the set of luminaires 206 may operate according to the locally-stored lighting setting). For example, the lighting setting for one luminaire 206 may specify a certain dim level and another lighting setting for another luminaire 206 may specify another dim level.

In this regard, the set of luminaires 206 may support both an emergency lighting mode and a main lighting mode. This is in contrast to the lighting system 100 of FIG. 1, in which the first set of luminaires 101 is associated with the emergency lighting mode and the second set of luminaires 102 is associated with the main lighting mode. Further, the ATS 220 includes a single power out or “hot” to the set of luminaires 206 for powering either the emergency lighting mode or the main lighting mode. This is further in contrast to the lighting system 100 of FIG. 1, in which the ATS 120 requires two power outs or “hots” to the sets of luminaires 101, 102 for powering either the emergency lighting mode or the main lighting mode.

Additionally, the wired connection from the ATS 220 to the set of luminaires 206 may share the components (e.g., the conduit, switches, meters, insulated conductors) of the wiring configuration 226. This is also in contrast to the lighting system 100 of FIG. 1, in which the first set of luminaires 101 is supported by the wiring configuration 122 and the second set of luminaires 102 is associated with the wiring configuration 124.

As depicted in FIG. 2, one or more client devices 218 may connect to the bridge device(s) 219 via the network(s) 216. The client device 218 may be any type of electronic device such as a smartphone, a desktop computer, a laptop, a tablet, a phablet, a smart watch, smart glasses, wearable electronics, pager, personal digital assistant, or any other electronic device, including computing devices configured for wireless radio frequency (RF) communication.

The client device(s) 218 may support a graphical user interface (GUI) whereby a user of the client device 218 may use the GUI to select various operations, change settings, view operation statuses and reports, make updates, configure email/text alert notifications, and/or perform other functions. For example, the user may use the client device 218 to set or modify parameters associated with any of the set of lighting settings. For further example, the user may use the client device 218 to assess the operation state of the current lighting mode of the lighting system 200. The client device(s) may transmit, via the network 216 and the bridge device(s) 219, any updated lighting settings to the set of luminaires 206 for implementation and/or storage thereon. Accordingly, the lighting system 200 may support remote and dynamic updating of the set of lighting settings.

Although not shown in FIG. 2, the client device(s) 218 may facilitate data communications via a gateway access point that may be connected to the bridge device(s) 219, which are connected to the set of luminaires 206. In one implementation, the gateway access point may be a cellular access point that includes a gateway, an industrial Ethernet switch, and a cellular router integrated into a sealed enclosure. Further, the gateway access point may be secured using HTTPS with a self-signed certificate for access to web services, and may push/pull data between various websites, the one or more bridge devices 219, and the set of luminaires 206.

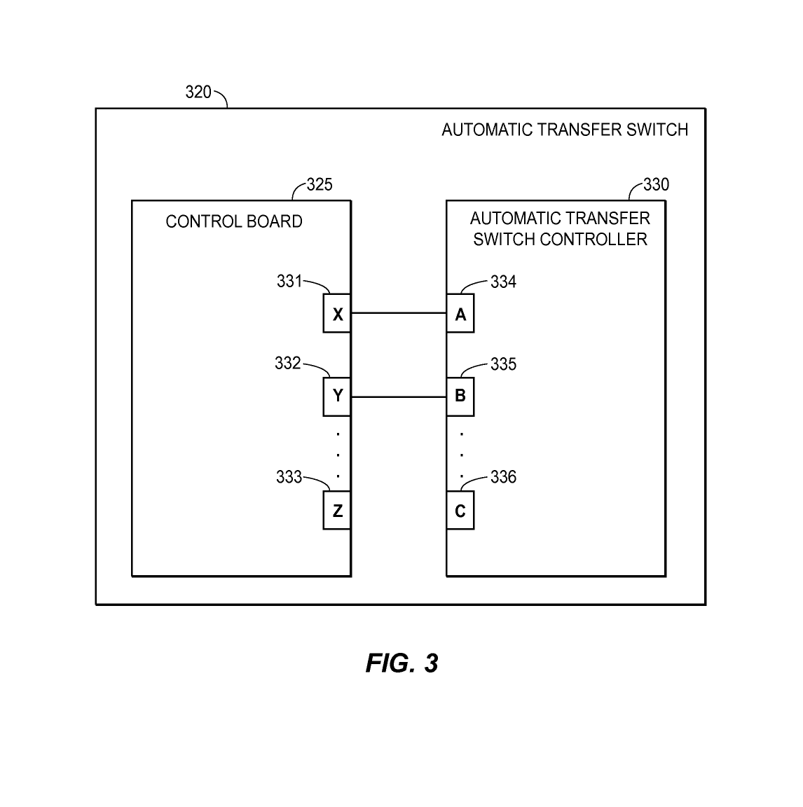

FIG. 3 depicts a detailed schematic of an ATS 320 and related components. In particular, FIG. 3 illustrates port connections associated with the ATS 320 and the related components. The ATS 320 may include an ATSC 330 and a control board 325 (such as the control board 225 discussed with respect to FIG. 2). The combination of the ATSC 330 and the control board 325 may be configured to detect current lighting modes and facilitate operation of the lighting modes and settings associated therewith. Although FIG. 3 depicts the ATSC 330 and the control board 325 as part of the ATS 320, it should be appreciated that either or both of the ATSC 330 and the control board 325 may be physically separated from the ATS 320.

The control board 325 is configured to interface with the ATSC 330 via a set of wires and a set of ports. As depicted in FIG. 3, the ATSC 330 includes at least three ports: port A 334, port B 335, and port C 336, and the control board 325 also includes at least three ports: port X 331, port Y 332, and port Z 333. It should be appreciated that FIG. 3 is merely exemplary, and that either or both of the ATSC 330 and the control board 325 may include fewer or additional ports.

In one implementation, the control board 325 may connect to the ATSC 330 via two ports of the ATSC 330: a “generator start” port and a “pre-transfer” port. The “pre-transfer” port is capable of sending a steady state output to the control board 325 indicating that there is an impending transfer or re-transfer of power sources. The “generator start” port may provide a normally open contact that closes to command a start of an emergency power source, such as a generator.

The control board 325 may therefore receive and analyze the signals from the ports of the ATSC 330 to determine a current or subsequent lighting mode (e.g., emergency lighting mode or main lighting mode), and to facilitate operation of the current or subsequent lighting mode accordingly. For example, the control board 325 may receive and analyze a signal from the “generator start” port and determine that the emergency power supply is starting, and thus that the emergency lighting mode should be initiated. Accordingly, the control board 325 may generate a command to implement an emergency lighting setting and transmit the command to the appropriate luminaires, as discussed with respect to FIG. 2. For further example, the control board 325 may receive and analyze a signal from the “pre-transfer” port and determine that the ATSC 330 is facilitating transfer from the emergency lighting mode to the main lighting mode. Accordingly, the control board 325 may generate a command to implement a main lighting setting and transmit the command to the appropriate luminaires, as discussed with respect to FIG. 2.

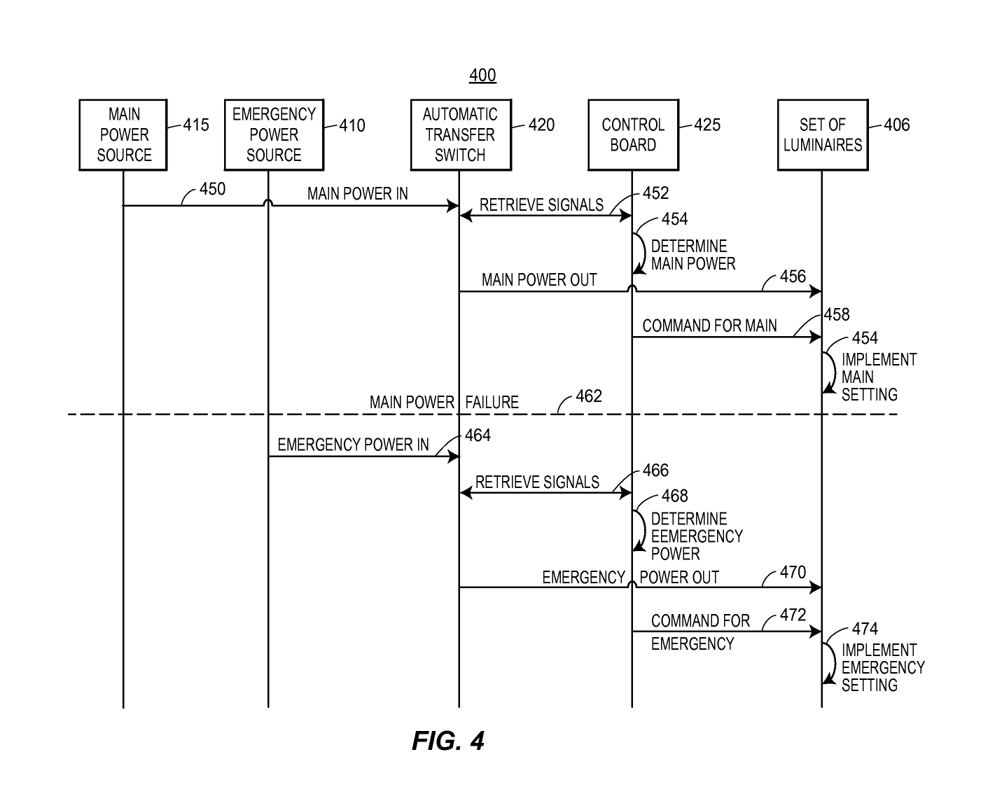

Referring to FIG. 4, depicted is an exemplary signal diagram 400 associated with facilitating various lighting modes in a lighting system. The signal diagram 400 includes a main power source 415 (such as the main power source 215 as described with respect to FIG. 2), an emergency power source 410 (such as the emergency power source 210 as described with respect to FIG. 2), an ATS 420 (such as the ATS 220 as described with respect to FIG. 2), a control board 425 (such as the control board 225 as described with respect to FIG. 2), and a set of luminaires (such as the set of luminaires 206 as described with respect to FIG. 2). Although not depicted in FIG. 4, the ATS 420 may include an ATSC configured to interface with the control board 425.

The signal diagram 400 may begin when the main power source 415 supplies (450) main power to the ATS 420. The main power source 415 may be one or more electric generators that supply power through an electric power grid that is regulated by the electric power industry, as conventionally understood. Responsive to receiving the main power IN, the ATS 420 may enable (456) main power OUT to the set of luminaires 406 so that the set of luminaires 406 are powered by the main power source 415.

Before, concurrently with, or after the ATS 420 enables main power OUT, the control board 425 may retrieve (452) signals from the ATS 420, or otherwise the ATS 420 may provide the signals to the control board 425. In embodiments, the control board 425 may be connected to one or more ports of the controller of the ATS 420. For example, the control board 425 may be wired to the pre-transfer port and/or the generator start port of the controller of the ATS 420. The control board 425 may examine/analyze the retrieved signals to determine (454) that the main power is active. For example, the pre-transfer signal and/or the generator start signal may indicate that the generator is not activated and/or that there is no impending transfer of power.

The control board 425 may generate a command to implement a main lighting setting stored on the set of luminaires 406, where the main lighting setting includes operation parameters for the set of luminaires 406 during a main power mode. The control board 425 may send (458) the command to the set of luminaires 406 via an appropriate bridge device, and the set of luminaires may access the main lighting setting to accordingly implement (460) the main lighting setting. Accordingly, when the ATS 420 transmits main power to the set of luminaires 406, the set of luminaires 406 operate according to the main lighting setting.

As depicted in FIG. 4, at 462, there may be a main power failure. It should be appreciated that the main power failure may occur for a variety of reasons, such as a power outage on a local power grid. Accordingly, the ATS 420 may transfer to emergency power and the emergency power source 410 may accordingly supply (464) emergency power to the ATS 420. The emergency power source 410 may include one or more generators, batteries, or the like capable of supplying power in situations in which the main power source 415 is unavailable or inoperable, as conventionally understood.

Responsive to receiving the emergency power IN, the ATS 420 may enable (470) emergency power OUT to the set of luminaires 406 so that the set of luminaires 406 are powered by the emergency power source 410. Before, concurrently with, or after the ATS 420 enables emergency power OUT, the control board 425 may retrieve (466) signals from the ATS 420, or otherwise the ATS 420 may provide the signals to the control board 425. In embodiments, as discussed above, the control board 425 may be connected to one or more ports of the controller of the ATS 420. For example, the control board 425 may be wired to the pre-transfer port and/or the generator start port of the controller of the ATS 420. The control board 425 may examine/analyze the retrieved signals to determine (468) that the emergency power is active. For example, the pre-transfer signal and/or the generator start signal may indicate that the generator is activated and/or that there is an impending transfer of power.

The control board 425 may generate a command to implement an emergency lighting setting stored on the set of luminaires 406, where the emergency lighting setting includes operation parameters for the set of luminaires 406 during an emergency power mode. The control board 425 may send (472) the command to the set of luminaires 406 via an appropriate bridge device, and the set of luminaires may access the emergency lighting setting to accordingly implement (460) the emergency lighting setting. Accordingly, when the ATS 420 transmits emergency power to the set of luminaires 406, the set of luminaires 406 operate according to the emergency lighting setting.

Although the signal diagram 400 of FIG. 4 describes a transfer from main power to emergency power, it should be appreciated that a similar transfer from emergency power to main power is envisioned.

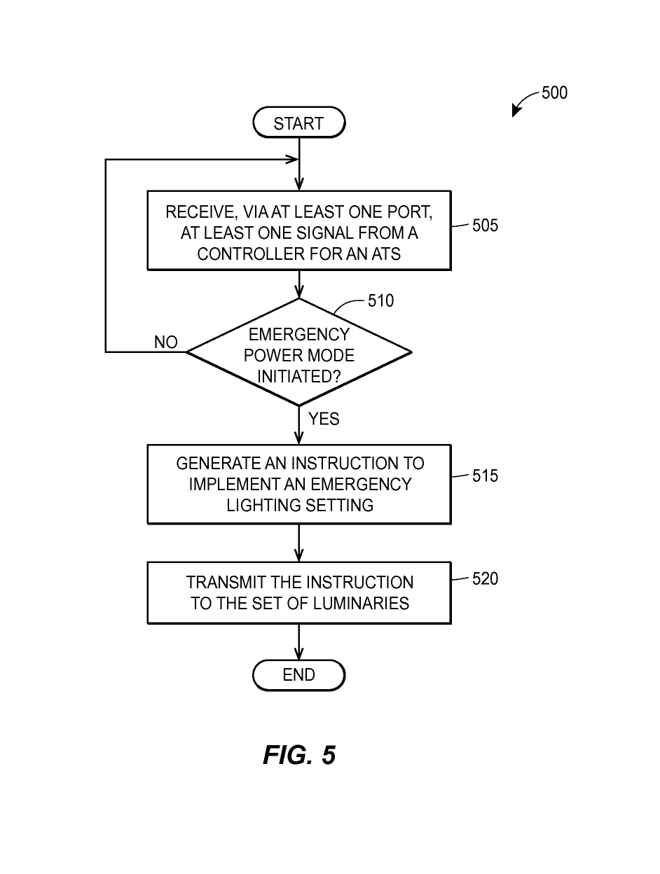

FIG. 5 is a flowchart of a method 500 of managing multiple lighting modes for a set of luminaires. According to embodiments, the multiple lighting modes may include a main power mode having a main lighting setting and an emergency power mode having an emergency lighting setting. Further, when the current lighting mode is the main power mode, the set of luminaires may be powered by a main power source. Similarly, when the current lighting mode is the emergency power mode, the set of luminaires may be powered by an emergency power source. As described, the method 500 may be facilitated by an electronic device such as a control board that is configured to interface with a controller of an ATS, where the ATS is connected to a main power source and an emergency power source. However, it should be appreciated that other components or combinations of components may facilitate the method 500.

The method 500 may begin when the electronic device receives (block 505), via at least one port, at least one signal from the controller of the ATS. In embodiments, the at least one signal may include a generation start signal, a pre-transfer signal, and/or another signal(s), from at least one corresponding port of the controller of the ATS. The electronic device may determine (block 510), based on the at least one signal, whether the emergency power mode is initiated. In particular, the electronic device may examine the received at least one signal to determine that the ATS is facilitating a transfer from the main power mode to the emergency power mode, or that the emergency power source is initiating. If the electronic device determines that the emergency power mode is not initiated (“NO”) (i.e., that the ATS is not transferring from main power to emergency power), processing may return to block 505.

In contrast, if the electronic device determines that the emergency power mode is initiated (“YES”) (i.e., that the ATS is transferring from main power to emergency power), the electronic device may generate (block 515) an instruction to implement an emergency lighting setting associated with the emergency power mode. The emergency lighting setting may be locally stored on the set of luminaires, whereby the emergency lighting setting may specify certain dim levels, output wattages, timeouts, output schedules, and/or other parameters.

In one embodiment, each of the set of luminaires may maintain individual emergency lighting settings that may differ from the emergency lighting settings of the other luminaires. For example, an emergency lighting setting for a luminaire along an egress route may specify a certain dim level that is different than what another emergency lighting setting for another luminaire that is not along the egress route specifies. It should be appreciated that when the emergency power mode is initiated, then the ATS may transmit power to the set of luminaires from the emergency power source.

The electronic device may transmit (block 520) the instruction to the set of luminaires. In embodiments, the electronic device may transmit the instruction to the set of luminaires via a wired or wireless connection, such as via a LAN/WLAN, PAN/WPAN, or WAN/WWAN network, and/or via a set of intermediary bridge devices. When the set of luminaires receive the instruction, each of the set of luminaires may access its emergency lighting setting and accordingly implement the emergency lighting setting. Accordingly, the set of luminaires may receive power from the emergency power source, via the ATS, and may operate according to the emergency lighting setting. In some implementations, in implementing the emergency lighting setting, the set of luminaires may output power at an output level that is reduced (or, in some cases, increased) from the output level associated with a main lighting setting.

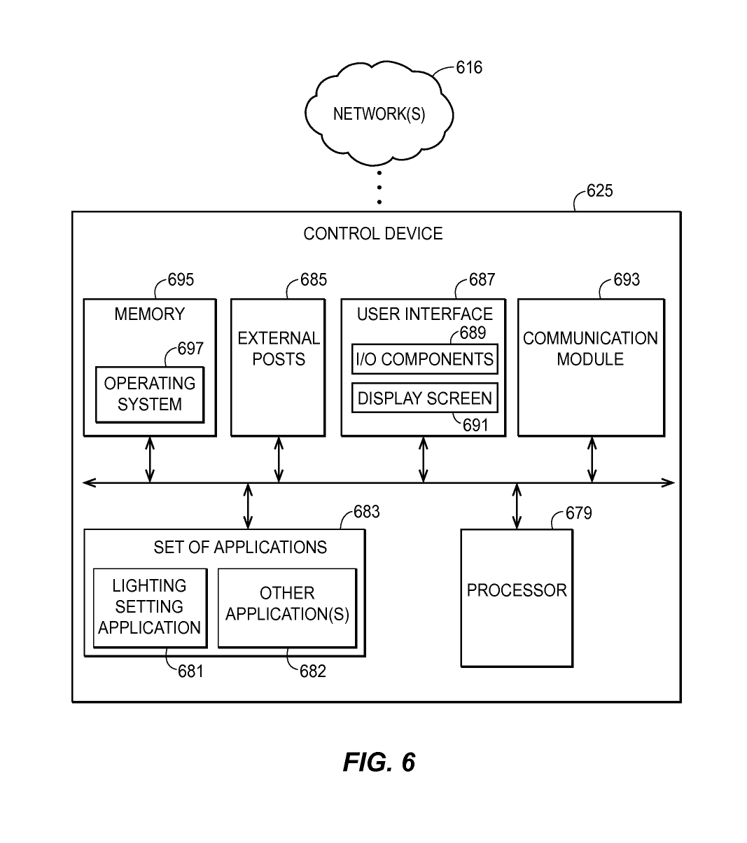

FIG. 6 illustrates an example control device 625 via which the functionalities as discussed herein may be implemented. In some embodiments, the control device 625 may be the control board 225 as discussed with respect to FIG. 2. Generally, the control device 625 is a dedicated machine, device, controller, or the like, including any combination of hardware and software components.

The control device 625 may include a processor 679 or other similar type of controller module or microcontroller, as well as a memory 695. The memory 695 may store an operating system 697 capable of facilitating the functionalities as discussed herein. The processor 679 may interface with the memory 695 to execute the operating system 697 and a set of applications 683. The set of applications 683 (which the memory 695 may also store) may include a lighting setting application 681 that is configured to generate commands or instructions to implement various lighting settings and transmit the commands/instructions to a set of luminaires. It should be appreciated that the set of applications 683 may include one or more other applications 682.

Generally, the memory 695 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The control device 625 may further include a communication module 693 configured to interface with one or more external ports 685 to communicate data via one or more networks 616. For example, the communication module 693 may leverage the external ports 685 to establish a WLAN for connecting the control device 625 to a set of luminaires and/or to a set of bridge devices. According to some embodiments, the communication module 693 may include one or more transceivers functioning in accordance with IEEE standards, 3GPP standards, or other standards, and configured to receive and transmit data via the one or more external ports 685. More particularly, the communication module 693 may include one or more wireless or wired WAN, PAN, and/or LAN transceivers configured to connect the control device 625 to the WANs, PANs, and/or LANs.

The control device 625 may further include a user interface 687 configured to present information to a user and/or receive inputs from the user. As illustrated in FIG. 6, the user interface 687 includes a display screen 691 and I/O components 689 (e.g., capacitive or resistive touch sensitive input panels, keys, buttons, lights, LEDs, cursor control devices, haptic devices, and others).

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 679 (e.g., working in connection with the operating system 697) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

Thus, it should be clear from the preceding disclosure that the systems and methods offer improved lighting systems. The embodiments advantageously enable efficient and effective control of lighting systems and reduce the complexity and components required in the installation of the lighting systems.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. A control board for facilitating multiple lighting modes for a set of luminaires, comprising:
a communication module adapted to interface with a bridge device via a network connection;
a memory storing a set of computer-executable instructions;
at least one port for interfacing with a controller for an automatic transfer switch (ATS); and
a processor adapted to interface with the communication module, the memory, and the at least one port, and configured to execute the set of computer-executable instructions to cause the processor to:
receive, via the at least one port, at least one signal from the controller for the ATS,
determine, based on the at least one signal, that the emergency power mode is initiated,
generate an instruction to implement an emergency lighting setting associated with the emergency power mode, and
transmit the instruction to the bridge device via the communication module, the set of luminaires configured to (i) access the instruction from the bridge device, and (ii) execute the instruction to implement the emergency lighting setting.

2. The control board of claim 1, wherein to transmit the instruction to the bridge device, the processor is configured to:
transmit the instruction to the bridge device via a wired connection.

3. The control board of claim 1, wherein to transmit the instruction to the bridge device, the processor is configured to:
transmit the instruction to the bridge device via a wireless connection.

4. The control board of claim 1, wherein the at least one signal is a generator start command, and wherein to determine, based on the at least one signal, that the emergency power mode is initiated, the processor is configured to:
determine, based on the generator start command, that an emergency power source is initiating.

5. The control board of claim 1, wherein the at least one signal is a pre-transfer signal, and wherein to determine, based on the at least one signal, that the emergency power mode is initiated, the processor is configured to:
determine, based on the pre-transfer signal, that the automatic transfer switch (ATS) is facilitating transfer from the main power mode to the emergency power mode.

6. A computer-implemented method of facilitating multiple lighting modes for a set of luminaires, the multiple lighting modes including a main power mode having a main lighting setting and an emergency power mode having an emergency lighting setting, the method comprising:
receiving, by a processor via at least one port, at least one signal from a controller for an automatic transfer switch (ATS) connected to a main power source and an emergency power source;
determining, by the processor based on the at least one signal, that the emergency power mode is initiated;
generating an instruction to implement the emergency lighting setting associated with the emergency power mode; and
transmitting the instruction to a bridge device via a communication module, the set of luminaires configured to (i) access the instruction from the bridge device, and (ii) execute the instruction to implement the emergency lighting setting with power from the emergency power source.

7. The computer-implemented method of claim 6, wherein transmitting the instruction to the bridge device comprises:
transmitting the instruction to the bridge device via a wired connection.

8. The computer-implemented method of claim 6, wherein transmitting the instruction to the bridge device comprises:
transmitting the instruction to the bridge device via a wireless connection.

9. The computer-implemented method of claim 6, wherein the at least one signal is a generator start command, and wherein determining, based on the at least one signal, that the emergency power mode is initiated comprises:
determining, based on the generator start command, that an emergency power source is initiating.

10. The computer-implemented method of claim 6, wherein the at least one signal is a pre-transfer signal, and wherein determining, based on the at least one signal, that the emergency power mode is initiated comprises:
determining, based on the pre-transfer signal, that the automatic transfer switch (ATS) is facilitating transfer from the main power mode to the emergency power mode.

11. A system for facilitating multiple lighting modes for a set of luminaires, comprising:
a controller for an automatic transfer switch (ATS) connected to an emergency power source and a main power source;
a bridge device; and
a control board configured to interface with the controller for the ATS and the bridge device via at least one port, the control board comprising:
a communication module adapted to interface with the bridge device via a network connection,
a memory storing a set of computer-executable instructions, and
a processor adapted to interface with the communication module and the memory, and configured to execute the set of computer-executable instructions to cause the processor to:
receive, via the at least one port, at least one signal from the controller for the ATS,
determine, based on the at least one signal, that the ATS is facilitating a transfer from a first power mode to a second power mode,
generate an instruction to implement a lighting setting associated with the second power mode, and
transmit the instruction to the bridge device via the communication module, a set of luminaires configured to (i) access the instruction from the bridge device, and (ii) execute the instruction to implement the lighting setting.

12. The system of claim 11, wherein the at least one signal is a generator start command, the first power mode is a main power mode, and the second power mode is an emergency power mode, and wherein to determine, based on the at least one signal, that the automatic transfer switch (ATS) is facilitating the transfer from the first power mode to the second power mode, the processor is configured to:
determine, based on the generator start command, that the emergency power source is initiating.

13. The system of claim 11, wherein the at least one signal is a pre-transfer signal, the first power mode is an emergency power mode, and the second power mode is a main power mode, and wherein to determine, based on the at least one signal, that the automatic transfer switch (ATS) is facilitating the transfer from the first power mode to the second power mode, the processor is configured to:
determine, based on the pre-transfer signal, that the automatic transfer switch (ATS) is facilitating transfer from the emergency power mode to the main power mode.

14. The system of claim 11, wherein to transmit the second lighting setting to the bridge device, the processor is configured to:
transmit the second lighting setting to the bridge device via a wired connection.

15. The system of claim 11, wherein to transmit the second lighting setting to the bridge device, the processor is configured to:
transmit the second lighting setting to the bridge device via a wireless connection.

16. A luminaire configured to implement multiple lighting settings, comprising:
a communication module adapted to interface with a bridge device;
at least one lamp;
a memory storing at least a main lighting setting associated with a main power mode and an emergency lighting setting associated with an emergency power mode; and
a processor adapted to interface with the communication module, the at least one lamp, and the memory, and configured to:
receive, from the bridge device via the communication module, an instruction to implement the emergency lighting setting associated with the emergency power mode, wherein the bridge device received the instruction from a control board,
in response to receiving the instruction, access, from the memory, the emergency lighting setting associated with the emergency power mode, and
cause the at least one lamp to output light according to the emergency lighting setting, the at least one lamp receiving power from an emergency power source.

17. The luminaire of claim 16, wherein the processor receives the instruction via a wired connection.

18. The luminaire of claim 16, wherein the processor receives the instruction via a wireless connection.

19. The luminaire of claim 16, wherein to cause the lamp to output the light according to the emergency lighting setting, the processor is configured to:
cause the at least one lamp to at least one of reduce output power or increase output power.

20. The luminaire of claim 16, wherein the processor is further configured to:
receive, via the communication module, a modified emergency lighting setting, and store the modified emergency lighting setting in the memory.
